(19) United States
(12) Patent Application Publication
(10) Pub. No.: US 2023/0273158 A1
(43) Pub. Date: Aug. 31, 2023

(54) ULTRASONIC METHOD AND SYSTEM FOR SIMULTANEOUSLY MEASURING LUBRICATION FILM THICKNESS AND LINER WEAR OF SLIDING BEARING

(71) Applicant: Xi'an Jiaotong University, Xi'an (CN)

(72) Inventors: Tonghai WU, Xi'an (CN); Wenzhuo ZHAO, Xi'an (CN); Pan DOU, Xi'an (CN); Peng ZHENG, Xi'an (CN); Yaping JIA, Xi'an (CN); Yaguo LEI, Xi'an (CN); Junyi CAO, Xi'an (CN)

(21) Appl. No.: 18/182,007

(22) Filed: Mar. 10, 2023

(30) Foreign Application Priority Data
Mar. 10, 2022 (CN) 202210240890.8

(51) Int. Cl. G01N 29/07; G01B 17/02; G01N 29/46

(52) U.S. Cl. CPC G01N 29/07; G01B 17/025; G01N 29/46; G01N 2291/011; G01N 2291/023; G01N 2291/02854; G01N 2291/101

(57) ABSTRACT

An ultrasonic method and system for simultaneously measuring lubrication film thickness and liner wear of sliding bearings. The method includes: installing an ultrasonic sensor on a bearing bush; sending, by a processor, signals to an ultrasonic pulser-receiver to generate voltage pulses to excite the ultrasonic sensor to generate ultrasonic pulses; collecting an echo signal of an unworn liner-air interface as a reference signal Bₐ(f); collecting an echo signal of worn liner-lubrication film interface as to-be-measured signal B_{ow}(f); obtaining an amplitude spectrum |Bₐ(f)| and a phase spectrum Φ_{B}_{ₐ}of Bₐ(f), an amplitude spectrum |B_{ow}(f)| and a phase spectrum Φ_{B}_{_{ow}}(f) of B_{ow}(f) by FFT; calculating an amplitude spectrum |R_{w}(f)|, and a phase spectrum Φ_{R}_{_{w}}(f) of a reflection coefficient; based on |R_{w}(f)|, calculating lubrication film thickness d via a resonance model or a spring model; and based on Φ_{R}_{_{w}}(f), calculating liner worn thickness via wear model under different film thicknesses.

### CROSS-REFERENCE TO RELATED APPLICATIONS

This application claims the benefit of priority from Chinese Patent Application No. 202210240890.8, filed on Mar. 10, 2022. The content of the aforementioned application, including any intervening amendments thereto, is incorporated herein by reference in its entirety.

### TECHNICAL FIELD

This application relates to the detection of lubrication state of friction pairs in machinery systems, and more particularly to an ultrasonic method and system for simultaneously measuring lubrication film thickness and liner wear of a sliding bearing.

### BACKGROUND

Fluid sliding bearing is a core component of large thermal power generator units and hydropower generator units. Regarding the fluid sliding bearing, there is a lubrication film formed by fluid to separate surfaces of the friction pairs of relative motion, so as to avoid direct contact between the friction pairs. Thus, the lubrication film state is closely associated with the bearing's behaviors, such as lubricating performance, loading capacity, running stability and service life. The thinning of the lubrication film will lead to direct contact between the solid components, resulting in wear failure, and even serious accidents such as bush burning and lubrication film oscillation. In this regard, the development of an online monitoring method for lubrication film thickness and bearing bush wear is of great significance for the fault early warning and condition-based maintenance of the units.

Regarding the measurement of lubrication film thickness, the non-intrusive ultrasonic technology enables the online measurement without disturbing the lubrication state and destroying the bearing structure. The ultrasonic reflection coefficient (the ratio of the reflected wave to the incident wave) will alter with the lubrication film thickness. Based on this, several mathematical models have been proposed to calculate the lubrication film thickness, including resonance model, spring model and phase model.

Regarding the wear measurement, online and offline methods are mainly employed. In the offline measurement, the wear degree is mainly evaluated by measuring the mass loss or the surface contour. Regarding the online measurement, eddy current sensors, linear potentiometers, laser displacement sensors, etc. are commonly used to measure the changes in the position and displacement of components before and after wear, so as to reflect the degree of wear. However, these sensors will damage the bearing bush structure when installed. In addition to the measurement of lubrication film thickness, the ultrasonic detection technology is also applicable to the wear measurement. Currently, the real-time measurement for wear degree of pin has been successfully achieved on the pin-on-disk test machine by using ultrasonic sensors. In this method, the resonance model and time-of-flight method are combined to measure the pin length after wear in real time, and then the length measured after wear is subtracted from the original pin length to evaluate the wear degree of the pin. However, the existing ultrasonic techniques can only achieve the single monitoring of wear degree or film thickness. During the operation of sliding bearings, the bearing bush liner often suffers wear in the start-stop phase and the rubbing interaction phase. Further, the liner wear is often accompanied by changes in the incident ultrasonic signal and the signal reflected from the lubrication film. At this time, the wear degree of the bearing bush and the lubrication film thickness are both unknown variables. Currently, less attention has been paid on the research and analysis of relationship between bearing bush wear and lubrication film thickness. Thus, how to simultaneously measure lubrication film thickness and bearing wear through ultrasonic echo signals is a great challenge.

### SUMMARY

An object of this application is to provide an ultrasonic method and system for simultaneously measuring lubrication film thickness and liner wear of a sliding bearing to illustrate the relationship between the lubrication film thickness and the liner wear and enable the simultaneous measurement, so as to improve the accuracy of bearing condition monitoring and service life prediction under actual working conditions.

Technical solutions of this application are described as follows.

In a first aspect, this application provides an ultrasonic method for simultaneously measuring lubrication film thickness and liner wear of a sliding bearing, the sliding bearing comprises a bearing bush, a liner covered on the inner surface of the bearing bush, a lubrication film and a bearing journal; and the ultrasonic method comprises:
(S1) installing an ultrasonic sensor on an outer surface of the bearing bush; with an instruction sent from a processor, exciting, by a voltage pulse generated from the ultrasonic pulser-receiver, the ultrasonic sensor to generate and transmit ultrasonic pulses to the sliding bearing;
(S2) collecting an echo signal of an unworn liner-air interface as reference signal Bₐ(f), and collecting an echo signal of a worn liner-lubrication film interface as to-be-measured signal B_{ow}(f); obtaining an amplitude spectrum |Bₐ(f)| and a phase spectrum ΦBₐ(f) of the reference signal Bₐ(f), and an amplitude spectrum |B_{ow}(f)| and a phase spectrum ΦB_{ow}(f) of the to-be-measured signal B_{ow}(f) by fast Fourier Transform (FFT); and based on an amplitude relationship and a phase relationship of the reference signal before and after wear of the liner, calculating an amplitude spectrum |R_{w}(f)| and a phase spectrum ΦR_{w}(f) of a reflection coefficient of the lubrication film after wear of the liner;
(S3) based on the amplitude spectrum |R_{w}(f)| of the reflection coefficient, calculating a thickness d of the lubrication film via a resonance model or a spring model; and based on the phase spectrum ΦR_{w}(f) of the reflection coefficient, calculating a worn thickness of the liner via a wear model under different thicknesses of the lubrication film.

In an embodiment, in step (S2), the amplitude spectrum |R_{w}(f)| of the reflection coefficient and the phase spectrum ΦR_{w}(f) of the reflection coefficient are respectively calculated as follows:

$$\vert {R}_{w} ( f ) \vert = \frac{\vert {B}_{ow} ( f ) \vert}{\vert {B}_{aw} ( f ) \vert} = \frac{\vert {B}_{ow} ( f ) \vert}{\vert {B}_{a} ( f ) \vert} ; and \\ {Φ}^{{R}_{w}} ( f ) = {Φ}^{{B}_{ow}} ( f ) - {Φ}^{{B}_{aw}} ( f ) = {Φ}^{{B}_{ow}} ( f ) - {Φ}^{{B}_{a}} ( f ) + 4 π f \frac{Δ d}{{c}_{c}} ;$$

wherein B_{aw}(f) is the reference signal after the wear of the liner; Δd is the worn thickness of the liner; c_{c} represents the sound velocity of the ultrasonic pulses in the liner; f is a frequency of the ultrasonic pulses; and ΦB_{aw}(f) indicates a phase spectrum of the B_{aw}(f).

In an embodiment, a ratio of the Bₐ(f) to the B_{aw}(f) is expressed as follows:

$$\frac{{B}_{a} ( f )}{{B}_{aw} ( f )} = exp ( 4 i π f \frac{Δ d}{{c}_{c}} ) ;$$

an amplitude ratio of the Bₐ(f) to the B_{aw}(f) is expressed as follows:

$$\frac{\vert {B}_{a} ( f ) \vert}{\vert {B}_{aw} ( f ) \vert} = 1 ;$$

a phase difference between the Bₐ(f) and the B_{aw}(f) is expressed as follows:

$${Φ}^{{B}_{a}} ( f ) - {Φ}^{{B}_{aw}} ( f ) = 4 π f \frac{Δ d}{{c}_{c}} ;$$

wherein i represents imaginary unit;

In an embodiment, the Bₐ(f) and the B_{aw}(f) are respectively calculated as follows:

Bₐ(f)=I(f)exp(2iπftₛ)T_{sc} exp(2iπft_{c})exp(2iπft_{c})T_{cs} exp(2iπftₛ); and

B_{aw}(f)=I(f)exp(2iπftₛ)T_{sc} exp(2iπft_{cw})exp(2iπft_{cw})T_{cs} exp(2iπftₛ);

wherein I(f) indicates the ultrasonic pulses incident on the sliding bearing; tₛ is a propagation time of the ultrasonic pulses in the bearing bush; T_{sc} is an ultrasonic transmission coefficient at bearing bush-liner interface; t_{c} is a propagation time of the ultrasonic pulses in an unworn liner; t_{cw} is a propagation time of the ultrasonic pulses in a worn liner; and T_{cs} is an ultrasonic transmission coefficient at liner-bearing bush interface.

In an embodiment, in step (S3), the thickness d of the lubrication film is calculated via the resonance model through the following equation:

$$d = \frac{m λ}{2} = \frac{{mc}_{0}}{2 {f}_{m}} ;$$

wherein λ is wavelength of the ultrasonic pulses; m is an order of resonance frequency; and fₘ is an m-th order resonance frequency.

In an embodiment, in step (S3), the thickness d of the lubrication film is calculated via the spring model through the following equation:

$$d = \frac{{ρ}_{o} {c}_{o}^{2}}{2 π {fz}_{1} {z}_{3}} \sqrt{\frac{\vert {R}_{w} ( f ) \vert {( {z}_{1} + {z}_{3} )}^{2} - {( {z}_{1} - {z}_{3} )}^{2}}{1 - {\vert {R}_{w} ( f ) \vert}^{2}}} ;$$

wherein z₁ is an acoustic impedance of the liner, and is calculated as: z₁=ρ₁c₁; ρ₁ is a density of the liner; cc represents sound velocity of the ultrasonic pulses in the liner; z₃ is an acoustic impedance of the bearing journal, and is calculated as: z₃=ρ₃c₃; ρ₃ is a density of the bearing journal; c₃ represents sound velocity of the ultrasonic pulses in the bearing journal; ρₒ is a density of the lubrication film; and c₀ represents sound velocity of the ultrasonic pulses in the lubrication film.

In an embodiment, in step (S3), when the thickness d of the lubrication film is in a resonance model zone, the worn thickness Δd of the liner is calculated as follows:

$$Δ d = \frac{{c}_{c}}{4 π {f}_{m}} ( {Φ}^{{B}_{a}} ( {f}_{m} ) - {Φ}^{{B}_{ow}} ( {f}_{m} ) ) ;$$

wherein fₘ is the m-th order resonance frequency of the ultrasonic pulses at the lubrication film; c_{c} represents sound velocity of the ultrasonic pulses in the liner; ΦBₐ(fₘ) is a phase of the Bₐ(f); and ΦB_{ow}(fₘ) is a phase of the B_{ow}(f).

In an embodiment, in step (S3), when the thickness d of the lubrication film is in a spring model zone, the worn thickness Δd of the liner is calculated as follows:

$$Δ d = \frac{{c}_{c}}{4 π {f}_{c}} ( {Φ}^{{R}_{w}} ( {f}_{c} ) - {Φ}^{{B}_{ow}} ( {f}_{c} ) + {Φ}^{{B}_{a}} ( {f}_{c} ) ) ;$$

wherein f_{c} is the center frequency of the ultrasonic sensor; ΦB_{w}(f_{c}) is a phase of the reflection coefficient; ΦB_{ow}(f_{c}) is a phase of the B_{ow}(f); and ΦBₐ(f_{c}) is a phase of the Bₐ(f).

In an embodiment, according to a phase formula of the spring model, the phase spectrum ΦR_{w}(f) of the reflection coefficient is calculated as follows:

$${Φ}_{{R}_{w}} ( f ) = arctan ( \frac{4 π {fz}_{1} {z}_{3}^{2} / K}{( {z}_{1} - {z}_{3} ) + 4 {π}^{2} {{f}_{c}^{2} ( {z}_{1} {z}_{3} / K )}^{2}} ) ;$$

wherein

$$K = \frac{{ρ}_{o} {c}_{o}^{2}}{d} ,$$

and K is a stiffness of the lubrication film.

In an embodiment, in step (S3), in step (S3), when the thickness of the lubrication film is in a blind zone, the worn thickness Δd of the liner is calculated as follows:

$$Δ d \approx \frac{{c}_{c}}{4 π {f}_{c}} ( {Φ}^{{B}_{a}} ( {f}_{c} ) - {Φ}^{{B}_{ow}} ( {f}_{c} ) ) ;$$

wherein f_{c} is the center frequency of the ultrasonic sensor; ΦB_{ow}(f_{c}) is a phase of the B_{ow}(f); and ΦBₐ(f_{c}) is a phase of the Bₐ(f).

In a second aspect, this application provides an ultrasonic system for simultaneously measuring lubrication film thickness and liner wear of a sliding bearing, wherein the sliding bearing comprises the bearing bush, the liner covered on the inner surface of the bearing bush, the lubrication film and the bearing journal; and the ultrasonic system comprises:
an ultrasonic measurement system; and
a processor;
wherein the ultrasonic measurement system comprises an ultrasonic sensor, an ultrasonic pulser-receiver and a digitizer;
the processor is configured to send an instruction to the ultrasonic pulser-receiver; the ultrasonic pulser-receiver is configured to receive the instruction and generate a voltage pulse; the ultrasonic sensor is configured to generate ultrasonic pulses under excitation of the voltage pulse, transmit the ultrasonic pulses to the sliding bearing, and receive echo signals reflected from interfaces between different materials of the sliding bearing; and the digitizer is configured to receive and transmit the echo signals to the processor;
the processor is configured to:
collect the echo signal of the unworn liner-air interface as reference signal Bₐ(f),
collect the echo signal of the worn liner-lubrication film interface as to-be-measured signal B_{ow}(f);
obtain the amplitude spectrum |Bₐ(f)| and the phase spectrum ΦBₐ(f) of the reference signal Bₐ(f), and the amplitude spectrum |B_{ow}(f)| and the phase spectrum ΦB_{ow}(f) of the to-be-measured signal B_{ow}(f) by fast Fourier Transform (FFT);
based on the amplitude relationship and the phase relationship of the reference signal before and after wear of the liner, calculate the amplitude spectrum |R_{w}(f)| and the phase spectrum ΦR_{w}(f) of a reflection coefficient of the lubrication film after wear of the liner;
based on the amplitude spectrum |R_{w}(f)| of the reflection coefficient, calculate the thickness d of the lubrication film via the resonance model or the spring model;
based on the phase spectrum ΦR_{w}(f) of the reflection coefficient, calculate the worn thickness of the liner via the wear model under different thicknesses of the lubrication film.

Compared with the prior art, this application has the following beneficial effects.

With respect to the method and system provided herein, the lubrication film thickness and the worn thickness of the liner during the operation of sliding bearing are both taken into consideration. In this application, an amplitude ratio and phase difference between the reference signals before and after the wear of the liner are calculated through superposition principle of wave. The amplitude and phase of the lubrication film reflection coefficient after wear are characterized by the reference signal before the wear of the liner. Based on the amplitude of the reflection coefficient, the lubrication film thickness is calculated by using the resonance model or spring model. The liner worn thickness is calculated based on the reflection coefficient phase containing wear information. Compared with the existing ultrasonic methods that only monitors the lubrication film thickness or worn thickness, this application not only enables the simultaneous measurement of lubrication film thickness and liner worn thickness, but also improves the accuracy of the bearing state monitoring and service life prediction under actual working conditions.

In order to obtain the lubrication film thickness and the liner worn thickness, according to the acoustical reflection theory, the amplitude spectrum and phase spectrum of the lubrication film reflection coefficient after wear are constructed based on the reference signal before wear, thereby fully taking the influence of the liner wear on the ultrasonic measurement into consideration.

Based on the amplitude ratio and the phase difference between the reference signals before and after wear, the reference signal after wear is catheterized by the reference signal before wear, so as to overcome the difficulty in acquisition of the reference signals during operation of the sliding bearing.

Based on the superposition principle of wave, a propagation model of ultrasonic pulses in a bearing bush-worn liner structure and a propagation model of ultrasonic pulses in a bearing bush-unworn liner structure are established respectively to obtain an expression of the echo signal of the air interface (i.e., reference signal), so as to take the influence of the worn thickness on the reference signal into consideration.

The amplitude spectrum of the reflection coefficient after wear only contains lubrication film information. In order to obtain the lubrication film thickness in the resonance zone, the resonance model of the ultrasonic reflection coefficient is employed to calculate the lubrication film thickness.

The amplitude spectrum of the reflection coefficient after wear only contains lubrication film information. When the lubrication film is very thin, the spring model-amplitude formula of the reflection coefficient is employed to calculate the lubrication film thickness.

When the lubrication film thickness is in a resonance model zone, the phase of the reflection coefficient at the resonance frequency is 0. Based on the phase difference between the lubrication film echo signal at the resonance frequency and the reference signal before wear, the liner worn thickness is calculated.

When the lubrication film thickness is in a spring model zone, the worn thickness is calculated based on the difference relationship between phases of the reflection coefficient, the lubrication film echo signal and the reference signal before wear at the center frequency of the ultrasonic sensor.

The phase of the reflection coefficient in the spring model zone is calculated based on the measured lubrication film thickness by using the spring model-phase formula.

When the lubrication film thickness is in the blind zone, the small variation in the reflection coefficient phase is ignored. Based on the difference relationship between phases of the lubrication film echo signal and the reference signal before wear at the center frequency, the liner worn thickness is calculated.

In conclusion, by means of the ultrasonic technique, this application enables the simultaneous monitoring of two variables, i.e., liner wear and lubrication film thickness of sliding bearings, without measuring the lubrication film reference signal during the sliding bearing operation, which realizes the wear measurement in the presence of lubrication film, and facilitates the fault early warning and condition-based maintenance of the units.

The technical solutions in this application will be described in detail below with reference to the accompanying drawings and embodiments.

### BRIEF DESCRIPTION OF THE DRAWINGS

FIG. 1 is a schematic diagram of a radial sliding bearing;

FIG. 2a schematically illustrates propagation of the ultrasonic pulses in a bearing bush-unworn liner structure;

FIG. 2b schematically illustrates propagation of the ultrasonic pulses in a bearing bush-worn liner structure;

FIG. 3 is a schematic diagram of an experiment platform for calibrating lubrication film thickness and an ultrasonic measurement system;

FIGS. 4a-b show comparison between measured lubrication film thickness and actual lubrication film thickness under different wear degrees, where 4a: comparison between measured and actual thicknesses; and 4b: relative error;

FIGS. 5a-f show comparison between measured worn thickness and actual worn thickness of a liner under different lubrication film thicknesses, where 5a: measured worn thickness when the lubrication film thickness is in a resonance zone; 5b: relative error of the worn thickness when the lubrication film thickness is in the resonance model zone; 5c: measured worn thickness when the lubrication film thickness is in a spring model zone; 5d: relative error of the worn thickness when the lubrication film thickness is in the spring model zone; 5e: measured worn thickness when the lubrication film thickness is in a blind zone; and 5f: relative error of the worn thickness when the lubrication film thickness is in the blind zone; and

FIG. 6 is a schematic diagram of a working principle of this application;

In the drawings, 1, micrometer caliper; 2, upper nut; 3, clamping device; 4, lower nut; 5, movable steel column; 6, fixed steel column; and 7, ultrasonic piezoelectric ceramic sensor.

### DETAILED DESCRIPTION OF EMBODIMENTS

This application will be described in detail below with reference to the accompanying drawings and embodiments to clearly and completely illustrate the technical solutions. Obviously, described below are merely some embodiments of this application, and are not intended to limit this application. Based on the embodiments of this application, other embodiments obtained by those of ordinary skill in the art without paying creative effort shall fall within the scope of this application defined by the appended claims.

In this application, it should be understood that the terms “comprise” and “include” indicate the existence of the described features, integers, steps, operations, elements and/or components, but do not exclude the existence or addition of one or more other features, integers, steps, operations, elements, components and/or a collection thereof.

It should also be understood that the terminologies used herein are only intended to describe specific embodiments, and not to limit this application. As used herein, the singular forms “a”, “an”, and “the” are intended to include the plural unless otherwise specified.

It should further be understood that the terminology “and/or” as used in this disclosure refers to any and all possible combinations of one or more of the associated listed items, and includes such combinations. For example, A and/or B includes technical solution A, technical solution B, and a combination thereof. Additionally, the character “/” in this disclosure generally indicates that the relationship between the associated objects in the front and back of “/” is an “or” relationship.

It should be understood that even though the terms such as “first”, “second”, “third”, etc. may be used in this application to describe the preset range and the like, but these preset ranges should not be limited to these terms. These terms are only used to distinguish preset ranges from one another. For example, without departing from the scope of the embodiments of this application, the first preset range may also be referred to as the second preset range, and similarly, the second preset range may also be referred to as the first preset range.

Depending on the circumstances, the wording “if” as used herein can be interpreted as “at” or “when” or “in response to determining” or “in response to detecting.” Similarly, the phrases “if determined” or “if detected (the stated condition or event)” can be interpreted as “when determined” or “in response to determining” or “when detected (the stated condition or event) or “in response to detecting (a stated condition or event)”.

Accompanying drawings shows various structural schematic diagrams of the disclosed embodiments of this application. These accompanying drawings are not drawn to scale. Some details have been magnified for clarity, and some details may be omitted. The shapes, relative sizes and positional relationships of various regions and layers shown in the accompanying drawings are only exemplary. In practice, there may be deviations due to manufacturing tolerances or technical limitations. Moreover, those skilled in the art can additionally design the regions/layers with different shapes, sizes, relative positions as desired.

Provided herein is an ultrasonic method and system for simultaneously measuring lubrication film thickness and liner wear of a sliding bearing. The worn thickness of the liner only changes the phase of the reference signal, but do not change the amplitude. Based on this characteristic, an ultrasonic method for simultaneously measuring lubrication film thickness and liner wear of a sliding bearing is established. In this method, 1) based on an amplitude ratio of an echo signal of the worn liner-lubrication film interface to a reference signal before wear of the liner, a thickness of the lubrication film is calculated via an amplitude model of an ultrasonic reflection coefficient; 2) based on a phase difference between the echo signal of the worn liner-lubrication film interface after wear of the liner and the reference signal before wear of the liner, a wear model under different thicknesses of the lubrication film is established to quantify a wear degree of the liner of the sliding bearing. The method provided herein illustrates the relationship between the lubrication film thickness and the liner wear of the sliding bearing and enable the simultaneous measurement, so as to realize the wear measurement in the presence of lubrication film, and facilitate the fault early warning and condition-based maintenance of the units.

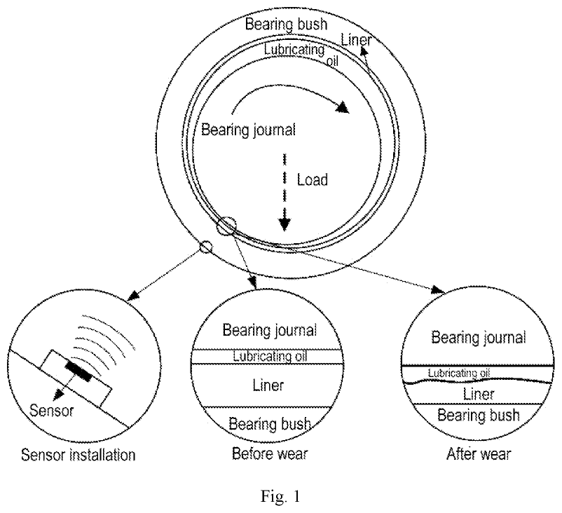

FIG. 1 is a schematic diagram of radial plain bearing. Referring to FIG. 1, the sliding bearing generally operates under fluid dynamic conditions, and an appropriate thickness of the lubrication film between the bearing journal and the bearing bush is formed and maintained. In order to avoid the contact wear between the bearing journal and the bearing bush under transient operating conditions such as start-stop phase of the machine, the inner surface of the bearing bush is generally covered with a wear-resistant liner. The thickness of the liner gradually decreases as the liner wear gradually accumulates. FIG. 1 shows cross-sectional views of the bearing bush before and after wear, and shows a schematic diagram of the placement of the ultrasonic sensor for measuring the worn thickness.

In order to facilitate the analysis, the radial sliding bearing with surface-contact friction pairs is shown as a four-layer parallel structure (i.e., bearing bush-liner-lubrication film-bearing journal structure). The sensor is installed on an outer surface of the bearing bush. In general, a wear surface of the liner is not uniform, as shown in an enlarged portion of FIG. 1. For the convenience of analysis, it is assumed that the measurement area is worn uniformly, and the wear interface remains parallel to the bearing bush-liner interface.

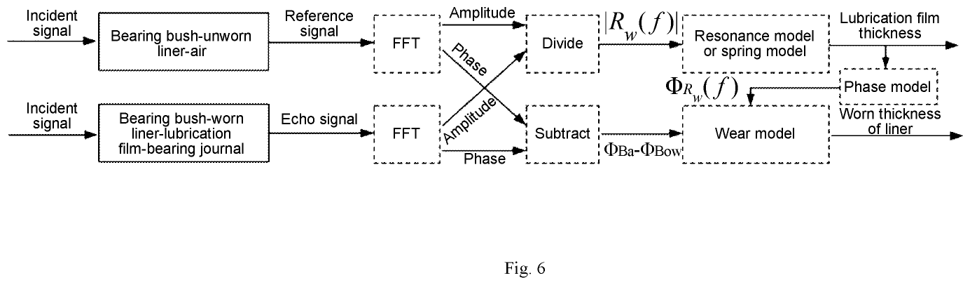

Referring to an embodiment shown in FIG. 6, provided herein is the ultrasonic method for simultaneously measuring lubrication film thickness and liner wear of a sliding bearing, which is performed as follows.

S1. Signal Acquisition and Spectrum Analysis

An ultrasonic sensor is attached to the outer surface of the bearing bush. A computer sends an instruction to an ultrasonic pulser-receiver to generate a voltage pulse to excite the ultrasonic sensor to generate and transmit ultrasonic pulses to the sliding bearing. An echo signal of an unworn liner-air interface is collected as a reference signal Bₐ(f) before wear of the liner. An echo signal of the lubrication film in a bearing bush-worn liner-lubrication film-bearing journal structure is collected as a to-be-measured signal B_{ow}(f). An amplitude spectrum |Bₐ(f)| and a phase spectrum ΦBₐ(f) of the reference signal Bₐ(f) and an amplitude spectrum |B_{ow}(f)| and phase spectrum ΦB_{ow}(f) of the to-be-measured signal B_{ow}(f) are obtained by fast Fourier Transform (FFT). Based on an amplitude relationship and a phase relationship of the reference signal before and after wear of the liner, an amplitude spectrum |R_{w}(f)| of a reflection coefficient of the lubrication film after wear of the liner and a phase spectrum ΦR_{w}(f) of the reflection coefficient are calculated.

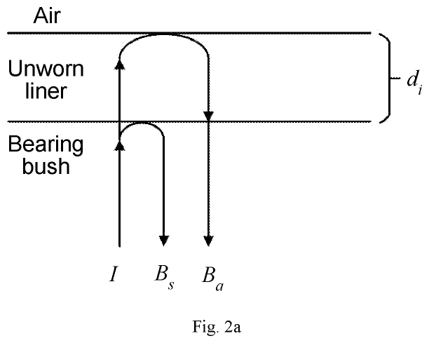

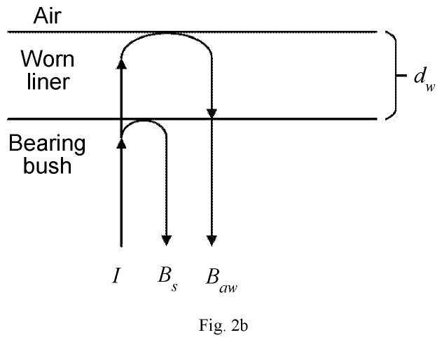

FIG. 2a schematically illustrates propagation of the ultrasonic pulses in a bearing bush-unworn liner structure. FIG. 2b schematically illustrates propagation of the ultrasonic pulses in a bearing bush-worn liner structure. Referring to FIGS. 2a-b, in the frequency domain, I(f) represents the incident wave; Bₛ(f) represents an echo signal reflected from the bearing bush-liner interface; an echo signal reflected back from the unworn liner-air interface to the ultrasonic sensor is Bₐ(f); an echo signal reflected back from the worn liner-air interface to the ultrasonic sensor is B_{aw}(f); dᵢ is a liner thickness before wear of the liner; d_{w} is a liner thickness after wear of the liner; and a worn thickness Δd is obtained by subtracting the liner thickness d_{w} after wear of the liner from the liner thickness dᵢ before wear of the liner.

The amplitude relationship and phase relationship of the reference signal before and after wear of the liner are illustrated as follows:

based on the superposition principle of wave, the reference signal Bₐ(f) before wear of the liner and the reference signal B_{aw}(f) after wear of the liner are theoretically calculated as follows:

Bₐ(f)=I(f)exp(2iπftₛ)T_{sc} exp(2iπft_{c})exp(2iπft_{c})T_{cs} exp(2iπftₛ)

B_{aw}(f)=I(f)exp(2iπftₛ)T_{sc} exp(2iπft_{cw})exp(2iπft_{cw})T_{cs} exp(2iπftₛ);

where I(f) indicates the ultrasonic pulses incident on the sliding bearing; tₛ is a propagation time of the ultrasonic pulses in the bearing bush; T_{sc} is an ultrasonic transmission coefficient of the ultrasonic pulses at a bearing bush-liner interface, where the bearing bush-liner interface corresponds to a propagation direction from the bearing bush to the liner, and T_{sc}=1+the reflection coefficient of the bearing bush-liner interface; t_{c} is a propagation time of the ultrasonic pulses in the unworn liner; t_{cw} is a propagation time of the ultrasonic pulses in the worn liner; and T_{cs} is an ultrasonic transmission coefficient of the ultrasonic pulses at a liner-bearing bush interface, where the liner-bearing bush interface corresponds to a propagation direction from the liner to the bearing bush, and T_{cs}=1−the reflection coefficient of the bearing bush-liner interface.

A ratio of the reference signal Bₐ(f) to the reference signal B_{aw}(f) is expressed as follows:

$$\begin{matrix}\frac{{B}_{a} ( f )}{{B}_{aw} ( f )} = exp ( 4 i π f ( {t}_{c} - {t}_{cw} ) ) ; \\ = exp ( 4 i π f ( \frac{{d}_{i}}{{c}_{c}} - \frac{{d}_{w}}{{c}_{c}} ) ) ; and \\ = exp ( 4 i π f \frac{Δ d}{{c}_{c}} ) ;\end{matrix}$$

where dᵢ is the liner thickness before wear; d_{w} is the liner thickness after wear; Δd is the worn thickness of the liner; c_{c} represents sound velocity of the ultrasonic pulses in the liner; and f is a frequency of the ultrasonic pulses.

An amplitude ratio of the Bₐ(f) to the B_{aw}(f) is expressed as follows:

$$\frac{\vert {B}_{a} ( f ) \vert}{\vert {B}_{aw} ( f ) \vert} = 1 ;$$

A phase difference between the Bₐ(f) and the B_{aw}(f) is expressed as follows:

$${Φ}^{{B}_{a}} ( f ) - {Φ}^{{B}_{aw}} ( f ) = 4 π f \frac{Δ d}{{c}_{c}} .$$

In conclusion, the amplitude ratio of the Bₐ(f) to B_{aw}(f) remains unchanged, and only a phase difference between Bₐ(f) and B_{aw}(f) is related to the worn thickness.

The amplitude spectrum |R_{w}(f)| of a reflection coefficient and the phase spectrum ΦR_{w}(f) of the reflection coefficient are respectively calculated as follows:

$$\vert {R}_{w} ( f ) \vert = \frac{\vert {B}_{ow} ( f ) \vert}{\vert {B}_{aw} ( f ) \vert} = \frac{\vert {B}_{ow} ( f ) \vert}{\vert {B}_{a} ( f ) \vert} ; and \\ {Φ}^{{R}_{w}} ( f ) = {Φ}^{{B}_{ow}} ( f ) - {Φ}^{{B}_{aw}} ( f ) = {Φ}^{{B}_{ow}} ( f ) - {Φ}^{{B}_{a}} ( f ) + 4 π f \frac{Δ d}{{c}_{c}} ;$$

where i represents imaginary unit; Δd is the worn thickness of the liner; c_{c} represents sound velocity of the ultrasonic pulses in the liner; and f is the frequency of the ultrasonic pulses.

### S2. Simultaneous Measurement of Lubrication Film Thickness and Worn Thickness of Liner

Based on the amplitude spectrum |R_{w}(f)| of the reflection coefficient of the lubrication film, a thickness d of the lubrication film is calculated via a resonance model or a spring model. Based on the phase spectrum ΦR_{w}(f) of the reflection coefficient of the lubrication film, a worn thickness of the liner is calculated via a wear model under different thicknesses of the lubrication film.

It can be concluded that an amplitude ratio of the echo signal B_{ow}(f) of the worn liner-lubrication film interface to the reference signal Bₐ(f) before wear of the liner still equals to the amplitude |R_{w}(f)| of the reflection coefficient of the lubrication film after wear of the liner. Therefore, for the resonance model and the spring model, even if the surface of the liner is worn, the amplitude of the reflection coefficient can still be directly used to calculate the lubrication film thickness.

The thickness d of the lubrication film is calculated via a resonance model through the following equation:

$$d = \frac{m λ}{2} = \frac{{mc}_{0}}{2 {f}_{m}} ;$$

where λ is wavelength of the ultrasonic pulses; m is an order of a resonance frequency; and fₘ is an m-th order resonance frequency.

The thickness d of the lubrication film is calculated via the spring model through the following equation:

$$d = \frac{{ρ}_{o} {c}_{0}^{2}}{2 π {fz}_{1} {z}_{3}} \sqrt{\frac{\vert {R}_{w} ( f ) \vert {( {z}_{1} + {z}_{3} )}^{2} - {( {z}_{1} - {z}_{3} )}^{2}}{1 - {\vert {R}_{w} ( f ) \vert}^{2}}} ;$$

where z₁ is an acoustic impedance of the liner, and is calculated as: z₁=ρ₁c_{c}; ρ₁ is a density of the liner; c_{c} represents sound velocity of the ultrasonic pulses in the liner; z₃ is an acoustic impedance of the bearing journal, and is calculated as: z₃=ρ₃c₃; ρ₃ is a density of the bearing journal; c₃ represents sound velocity of the ultrasonic pulses in the bearing journal; ρ₀ is a density of the lubrication film; and c₀ represents sound velocity of the ultrasonic pulses in the lubrication film.

Based on the phase spectrum ΦR_{w}(f) of the reflection coefficient, the wear model under different thicknesses of the lubrication film is illustrated as follows.

The phase difference between the echo signal B_{ow}(f) of the lubrication film after wear of the liner and the reference signal B_{aw}(f) after wear of the liner contains the lubrication film thickness information and the linear wear information. The thickness d of the lubrication film is known, and the phase Φ_{Rw}(f) of the reflection coefficient is calculated according to a phase formula of reflection coefficient, which is shown as follows:

$${Φ}^{R} ( f ) = {Φ}^{S} ( f ) - {Φ}^{I} ( f ) = {tan}^{- 1} [ \frac{{V}_{23} ( 1 - {V}_{12}^{2} ) sin ( \frac{4 π fd}{{c}_{0}} )}{{V}_{12} ( 1 + {V}_{23}^{2} ) + {V}_{23} ( 1 + {V}_{12}^{2} ) cos ( \frac{4 π fd}{{c}_{0}} )} ] ;$$

where d is the thickness of the lubrication film; f is a frequency of the ultrasonic pulses; cₒ represents sound velocity of the ultrasonic pulses in the lubrication film; V₁₂ is a reflection coefficient at a “liner-lubrication film” interface; and V₂₃ is a reflection coefficient at an “lubrication film-bearing journal” interface.

If the thickness of the lubrication film is in a resonance model zone:

when f=fₘ, based on a calculation through the phase formula of reflection coefficient, ΦR_{w}(fₘ)=0 is obtained, and the worn thickness Δd of the liner is calculated as follows:

$$Δ d = \frac{{c}_{c}}{4 π {f}_{m}} ( {Φ}^{{B}_{a}} ( {f}_{m} ) - {Φ}^{{B}_{ow}} ( {f}_{m} ) ) ;$$

where fₘ is an m-th order resonance frequency of the ultrasonic pulses at lubrication film.

If the lubrication film thickness is in the spring model zone:

the thickness d of the lubrication film is calculated by using a spring model-amplitude method. According to the spring model-phase formula, based on the thickness d of the lubrication film, the phase spectrum ΦR_{w}(f) is calculated, and further a worn thickness Δd of the liner is obtained as follows.

The phase formula of the spring model method is expressed as follows:

$${Φ}_{{R}_{w}} ( f ) = arctan ( \frac{4 π {fz}_{1} {z}_{3}^{2} / K}{( {z}_{1} - {z}_{3} ) + 4 {π}^{2} {{f}_{c}^{2} ( {z}_{1} {z}_{3} / K )}^{2}} ) ;$$

where K is stiffness of the lubrication film, and is calculated as:

$$K = \frac{{ρ}_{o} {c}_{o}^{2}}{d} ,$$

ρₒ is a density of the lubrication film; cₒ represents sound velocity of the ultrasonic pulses in the lubrication film; and d is the thickness of the lubrication film.

The worn thickness Δd of the liner is calculated as follows:

$$Δ d = \frac{{c}_{c}}{4 π {f}_{c}} ( {Φ}^{{R}_{w}} ( {f}_{c} ) - {Φ}^{{B}_{ow}} ( {f}_{c} ) + {Φ}^{{B}_{a}} ( {f}_{c} ) ) ;$$

where f_{c} is a center frequency of the ultrasonic sensor, ΦR_{w}(f_{c}) is a phase spectrum of the reflection coefficient of the lubrication film after wear of the liner, c_{c} represents sound velocity of the ultrasonic pulses in the liner; ΦB_{ow}(f_{c}) is a phase spectrum of the to-be-measured signal; and ΦBₐ(f_{c}) is a phase spectrum of the reference signal Bₐ(f) before wear of the liner.

If the thickness of the lubrication film is in a blind zone:

since the amplitude of the reflection coefficient fails to predict the lubrication film thickness in the blind zone, the amplitude spectrum |R_{w}(f)| of the reflection coefficient fails to be used to calculate the lubrication film thickness in the blind zone after wear of the liner.

In the blind zone, the phase of the reflection coefficient changes little with the lubrication film thickness. The lubrication film thickness in the blind zone varies from 20 μm to 60 μm, and the variation of the phase of the reflection coefficient is 0.19 radians.

When ignoring the effect of the lubrication film thickness variation on the phase difference of the blind zone, a calculation model of the worn thickness Ad of the liner is simplified as:

$$Δ d \approx \frac{{c}_{c}}{4 π {f}_{c}} ( {Φ}^{{B}_{a}} ( {f}_{c} ) - {Φ}^{{B}_{ow}} ( {f}_{c} ) ) ;$$

where f_{c} is the center frequency of the ultrasonic sensor.

In another aspect, this application provides an ultrasonic system for simultaneously measuring lubrication film thickness and liner wear of a sliding bearing, the sliding bearing. The sliding bearing includes a bearing bush, a liner covered on an inner surface of the bearing bush, a lubrication film and a bearing journal. The ultrasonic system includes an ultrasonic measurement system and a processor.

The ultrasonic measurement system includes an ultrasonic sensor, an ultrasonic pulser-receiver and a digitizer.

The processor is configured to send an instruction to the ultrasonic pulser-receiver to generate a voltage pulse to excite the ultrasonic sensor to generate and transmit ultrasonic pulses to the sliding bearing.

The ultrasonic sensor is configured to receive echo signals from interfaces between different materials of the sliding bearing.

The digitizer is configured to capture and transmit the echo signals to the processor.

The processor is configured to: store an echo signal of the an unworn liner-air interface as a reference signal Bₐ(f), store an echo signal of the worn liner-lubrication film interface as the to-be-measured signal B_{ow}(f); obtain an amplitude spectrum |Bₐ(f)| and a phase spectrum ΦBₐ(f) of the reference signal Bₐ(f) and an amplitude spectrum |B_{ow}(f)| and a phase spectrum ΦB_{ow}(f) of the to-be-measured signal B_{ow}(f) by fast Fourier Transform (FFT); calculate a thickness d of the lubrication film via a resonance model or a spring model based on the ratio of the amplitude spectrum of the to-be-measured signal to the amplitude spectrum of the reference signal; simultaneously solve the phase of the reflection coefficient based on the calculated thickness of the lubrication film; obtain a phase shift resulted from wear of the liner by subtracting the phase of the reference signal and the phase of the reflection coefficient from the phase of the to-be-measured signal; and calculate the worn thickness of the liner based on the phase shift resulted from wear of the liner.

In some embodiments, the ultrasonic system provided herein further includes a computer-readable storage medium. The executable instructions are stored on the computer-readable storage medium. The instructions are executed by the processor to implement the steps in the above method.

In order to make the objections, technical solutions, and advantages of embodiments in this application clearer and more complete, this application will be described in detail with reference to the accompanying drawings in the following embodiments. Obviously, described below are merely some embodiments of this application, and are not intended to limit this application. Generally, the components described in the embodiments and demonstrated in the accompanying drawings herein can be arranged and designed in a variety of different configurations. Accordingly, the detailed description of the following embodiments provided in the accompanying drawings is intended to indicate the selected embodiments of this application, but not to limit this application. Based on the embodiments provided herein, all other embodiments obtained by those of ordinary skill in the art without paying creative effort shall fall within the protection scope of this application defined by the appended claims.

### Verification Example

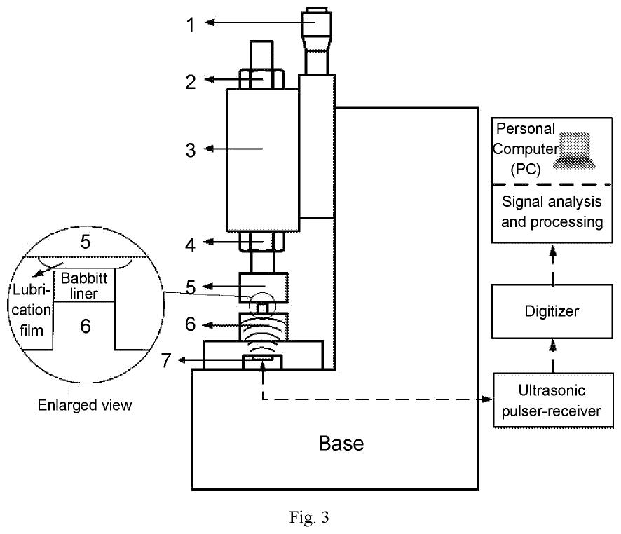

Referring to FIG. 3, an experiment platform for lubrication film thickness calibration and an ultrasonic measurement system include a micrometer caliper 1, an upper nut 2, a clamping device 3, a lower nut 4, a movable steel column 5, a fixed steel column 6 and an ultrasonic piezoelectric ceramic sensor 7.

The experiment platform for lubrication film thickness calibration enables verification of effectiveness of the method. The experimental device includes two parts consisting of a displacement table to control the lubrication film thickness and an ultrasonic measurement system.

The fixed steel column 6 is installed on a base. The ultrasonic piezoelectric ceramic sensor 7 with a center frequency of 8 MHz is adhered to a groove on a back portion of the fixed steel column 6 by using a high-temperature adhesive. The micrometer caliper 1 is fixed on a side end surface of the base. The clamping device 3 connects the micrometer caliper 1 and the movable steel column 5. The movable steel column 5 and the fixed steel column 6 are coaxial. The movable steel column 5 is fixed through the upper nut 2 on an upper end surface of the clamping device 3 and the lower nut on a lower end surface of the clamping device 3.

The fixed steel column 6 is processed from a complete sliding pad with a very small cylinder (diameter Φ5 mm×thickness 5 mm), which is mainly designed for reducing the surface tension and the extrusion effect of the lubrication film. Moreover, the fixed steel column 6 has a 2 mm babbitt liner on top. The gap between the movable steel column 5 and the fixed steel column 6 is designed for forming the lubrication film. The micrometer caliper 1 is configured for coarse adjustment of the lubrication film thickness. The micrometer caliper 1 has a height adjustment range of 0-18 mm and a resolution of 10 μm.

The ultrasonic measurement system includes an ultrasonic piezoelectric ceramic sensor 7 (i.e., ultrasonic sensor), the ultrasonic pulser-receiver, the digitizer and a computer. During measurement, the computer sends an instruction to the ultrasonic pulser-receiver to generate a voltage pulse, which further excites the ultrasonic sensor to generate ultrasonic pulses with certain frequency bands. The ultrasonic pulses are transmitted to the structure to be measured. Due to the different acoustic impedance of different media, the ultrasonic pulses are reflected and transmitted at different interfaces among different media. Part of the echo pluses are received by the ultrasonic sensor and excite the electrical pulses of the sensor, which are collected by a 12-bit 100 MSps digitizer and transmitted to the computer for processing.

The echo signal of the fixed steel column-air interface is collected and stored as the reference signal Bₐ(f). The babbitt liner on the surface of the fixed steel column 6 is sanded by the sandpaper. The lubricating oil is dripped onto the surface of the fixed steel column 6. The micrometer caliper 1 is configured for adjusting the position of the movable steel column 5 to generate the lubrication film thickness in the resonance model zone. The lubrication film thickness in the resonance model area is calculated by the minimal value point method of the resonance model, and is taken as a reference value. The micrometer caliper 1 gradually decreases the lubrication film thickness from the resonance model zone to the spring model zone with a step length of 10 μm. During this process, the difference value between the reference value of lubrication film thickness and the displacement increment of the micrometer caliper 1 is taken as an actual lubrication film thickness. The echo signals of the lubrication film at different thicknesses are collected and stored. After the calibration, the babbitt liner is further sanded with the sandpaper, and the calibration is repeated. Additionally, the echo signal of the fixed steel column-air interface after each sanding by the sandpaper is collected as the reference signal B_{aw}(f) after wear. According to the time-shifting variation of the reference signals before and after wear of the liner, a worn thickness is calculated by using traditional time-of-flight method, and is taken as the actual worn thickness. The actual worn thickness is calculated as follows:

$$Δ d = \frac{{c}_{c} Δ t}{2} ;$$

where c_{c} represents sound velocity of the ultrasonic pulses in the liner; Δt is a time-shifting difference between the reference signal Bₐ(f) before wear of the liner and the reference signal B_{aw}(f) after wear of the liner, and is calculated as: Δt=t_{c}−t_{cw}; t_{c} indicates a time taken for the echo signal reflected from the unworn liner-air interface to be received by the ultrasonic sensor; t_{cw} indicates a time taken for the echo signal reflected from the worn liner-air interface to be received by the ultrasonic sensor.

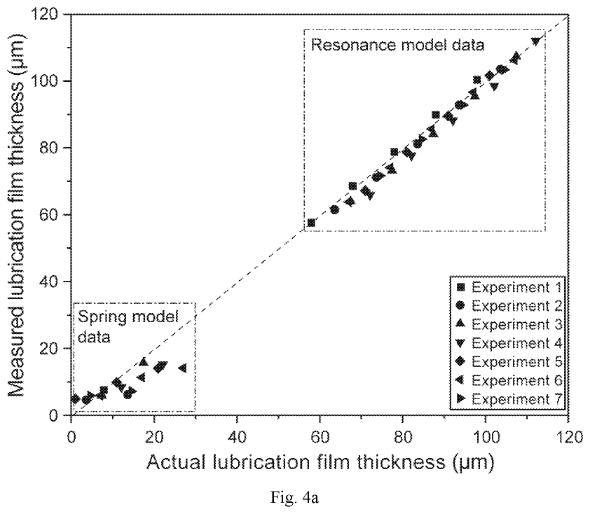

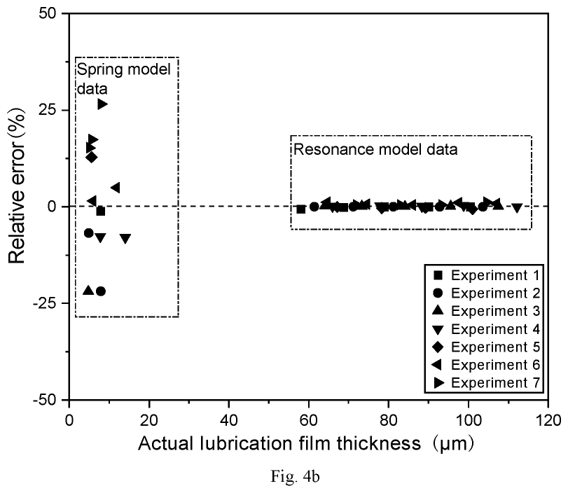

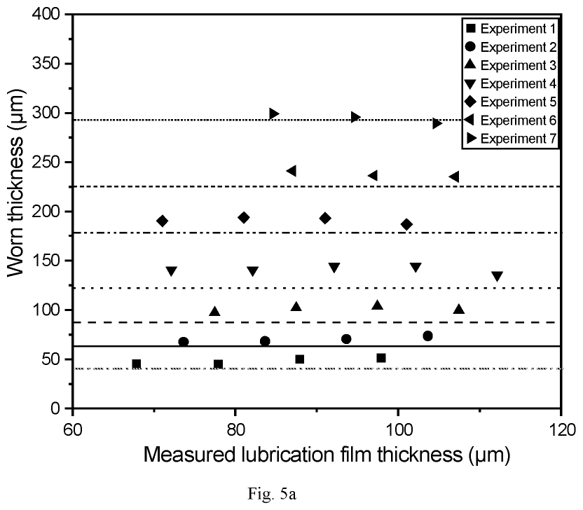

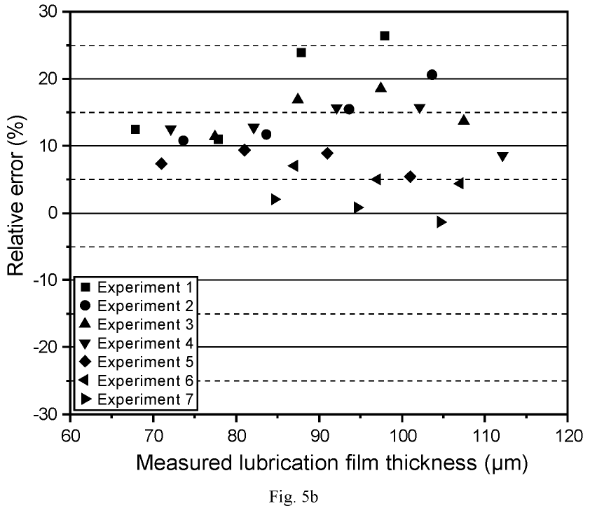

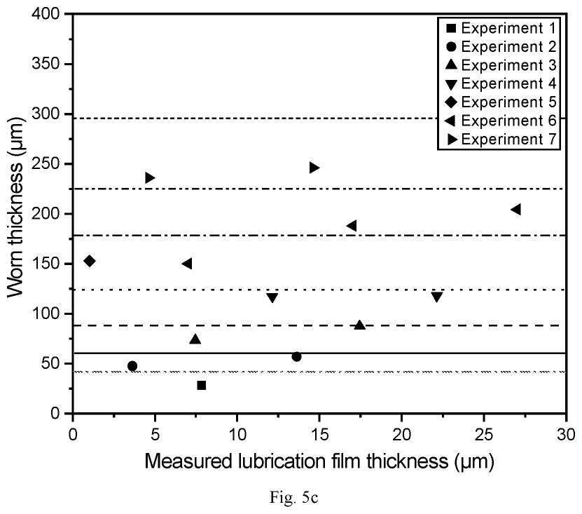

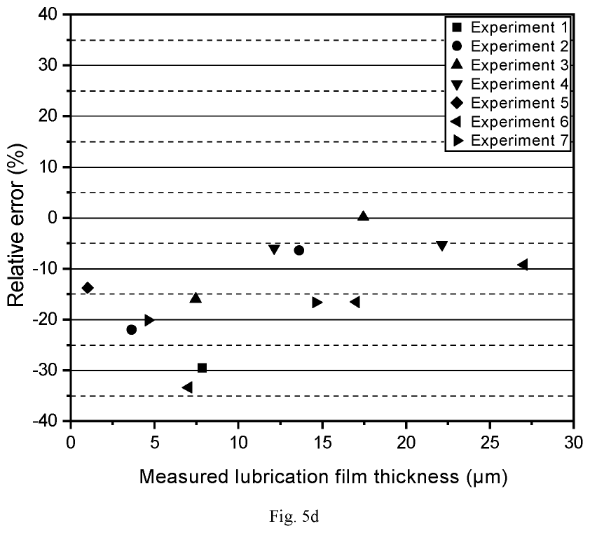

FIGS. 4a-b show comparison between measured lubrication film thickness and actual lubrication film thickness under different wear degrees, where 4a: comparison between measured and actual thicknesses; and 4b: relative error. Referring to FIGS. 4a-b, the calibration results of the lubrication film thickness under seven different worn thicknesses are illustrated. The results demonstrates that the calculated results for the resonance model and spring models essentially remain linear with the actual values.

For the spring model, due to the extrusion effect, the lubrication film with thickness below 2 μm cannot be formed by static lubrication film. Thus, the measured thickness of the lubrication film below 2 μm is larger than the actual thickness of the lubrication film. When the lubrication film thickness is higher than 5 μm the amplitude of the reflection coefficient is greater than 0.95. The amplitude changes slowly with the lubrication film thickness, and is easily affected by noise, resulting in larger measurement error.

Compared with the spring model, the measurement results of the resonance model are closer to the actual value, indicating that the minimal value method of the resonance model has higher accuracy in predicting the lubrication film thickness after wear of the liner. However, the micrometer caliper 1 has a resolution of 10 μm and an error of ±5 μm. In this case, the actual lubrication film thickness cannot be accurately controlled by using the experiment platform for lubrication film thickness calibration, and the errors still exist between the actual lubrication film thickness and measured lubrication film thickness.

In conclusion, the amplitude of the reflection coefficient after wear can be used to calculate the lubrication film thickness.

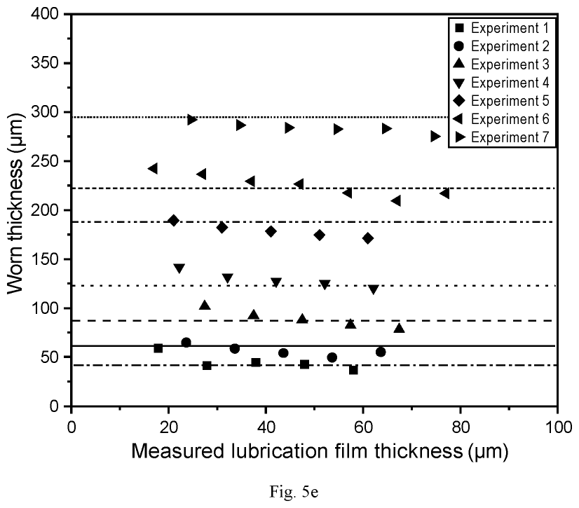

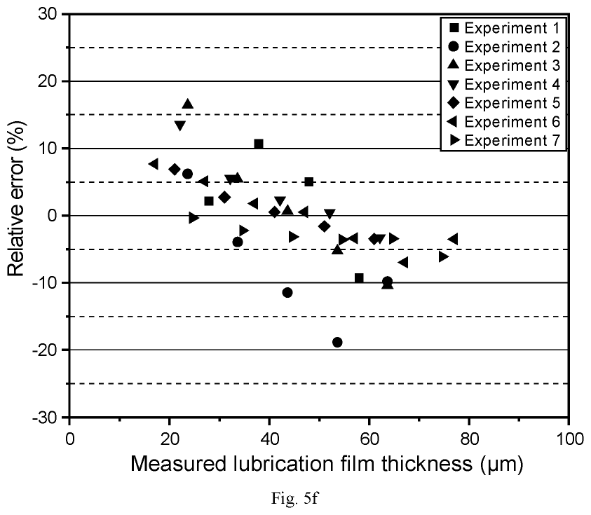

FIGS. 5a-f show comparison between measured worn thickness and actual worn thickness of a liner under different lubrication film thicknesses, where 5a: measured worn thickness when the lubrication film thickness is in an area of a resonance model; 5b: relative error of the worn thickness when the lubrication film thickness is in the resonance model zone; 5c: measured worn thickness when the lubrication film thickness is in an area of a spring model; 5d: relative error of the worn thickness when the lubrication film thickness is in the spring model zone; 5e: measured worn thickness when the lubrication film thickness is in a blind zone; and 5f: relative error of the worn thickness when the lubrication film thickness is in the blind zone. The seven horizontal lines from bottom to top shown in FIGS. 5a, c and e respectively represent the actual worn thickness of the liner in Experiments 1-7.

In the resonance model zone, as shown in FIG. 5a, the measured results of the resonance model are basically consistent with the actual worn thickness. Referring to FIG. 5b, the relative error decreases with the increase of the worn thickness.

In the spring model zone, as shown in FIG. 5d, the relative error of the calculated worn thickness is greater than that in the resonance model zone. Because the amplitude and phase of the reflection coefficient are sensitive to the lubrication film thickness in the area of spring model. Thus, it is inaccurate to calculate the phase of theoretical reflection coefficient based on the lubrication film thickness calculated by the amplitude.

In the blind zone, as shown in FIG. 5e, the calculated worn thickness decreases with the increase of the lubrication film thickness, which is consistent with the actual wear. Because the phase of the reflection coefficient gradually increases with the increase of the lubrication film thickness. However, when the worn thickness is calculated based on the worn thickness of the liner, the variation in the phase of the reflection coefficient is ignored. Therefore, the worn thickness decreases with the increase of the lubrication film thickness. In addition, as illustrated in FIG. 5f, the relative error is within ±20%, and decreases with the increase of the worn thickness. When the lubrication film thickness is unknown, the phase difference can still be used to roughly calculate the worn thickness of the blind zone.

In conclusion, according to the ultrasonic method and system provided herein for simultaneously measuring lubrication film thickness and liner wear of a sliding bearing, the influence of the worn thickness of the liner on an ultrasonic signal is taken into consideration. The lubrication film thickness and the liner worn thickness are simultaneously monitored during the operation process of the sliding bearing. In this application, an amplitude ratio and phase difference between the reference signals before and after wear of the liner are calculated through superposition principle of wave. The amplitude and phase of the lubrication film reflection coefficient after wear are characterized by using the reference signal Bₐ(f) before wear. Based on the amplitude of the reflection coefficient, the lubrication film thickness is calculated by using the resonance method or spring model method. The liner worn thickness is calculated based on the reflection coefficient phase containing wear information. Compared with the existing ultrasonic methods that only monitors the lubrication film thickness or worn thickness, this application not only enables the simultaneous measurement of lubrication film thickness and liner worn thickness, but also improves the accuracy of the bearing state monitoring and service life prediction under actual working conditions.

It should be understood by those skilled in the art that the embodiments provided herein can be method, system or computer programming product. Thus, this application may take the form of an embodiment of entire hardware, an embodiment of entire software or an embodiment combining software and hardware aspects. Furthermore, this application may take the form of a computer program product executed on one or more computer-usable storage media (including, but not limited to, magnetic-disk storage, Compact Disc Read- Only Memory (CD-ROM), optical storage, etc.).

This application is described with reference to flowchart illustrations and/or block diagrams of methods, apparatus (systems), and computer program products according to embodiments of this application. It should be understood that each flow in the flowchart and/or each block in block diagram, and combinations of flows and/or blocks in the flowchart and or block diagrams, can be implemented by computer program instructions. These computer program instructions may be provided to a processor of a general-purpose computer, special-purpose computer, embedded processor, or other programmable data processing apparatus to produce a machine. In this case, the instructions, which are executed via the processor of the computer or other programmable data processing apparatus, produce devices for carrying out the functions specified in one or more flows in a flowchart and/or one or more blocks in a block diagram.

These computer program instructions may also be stored in a computer-readable memory that can direct a computer or other programmable data processing apparatus to function in a particular manner, such that the instructions stored in the computer-readable memory produce a manufacture product containing instruction device. The instruction device is configured to realize the functions specified in one or more flows in the flowchart and/or one or more blocks in the block diagram.

The computer program instructions may also be loaded onto a computer or other programmable data processing apparatus, such that a series of operational steps can be executed on the computer or other programmable apparatus to enable processing on the computer. In this case, the instructions which are executed on the computer or other programmable apparatus provide steps for implementing the functions specified in the one or more flows in the flowchart and/or one or more blocks in the block diagram.

The above-mentioned embodiments are only illustrative of the technical solutions of this application, and are not intended to limit this application. It should be understood that various variations, modifications and replacements made by those skilled in the art without departing from the spirit of this application shall fall within the scope of this application defined by the appended claims.

What is claimed is:

1. An ultrasonic method for simultaneously measuring lubrication film thickness and liner wear of a sliding bearing, the sliding bearing comprising a bearing bush, a liner covered on an inner surface of the bearing bush, a lubrication film and a bearing journal; and the ultrasonic method comprising:
(S1) installing an ultrasonic sensor on an outer surface of the bearing bush; sending, by a processor, an instruction to an ultrasonic pulser-receiver to generate a voltage pulse; and exciting, by the voltage pulse, the ultrasonic sensor to generate and transmit ultrasonic pulses to the sliding bearing;
(S2) collecting an echo signal of an unworn liner-air interface as a reference signal Bₐ(f), and collecting an echo signal of a worn liner-lubrication film interface as a to-be-measured signal B_{ow}(f); obtaining an amplitude spectrum |Bₐ(f)| and a phase spectrum ΦBₐ(f) of the reference signal Bₐ(f) , and an amplitude spectrum |B_{ow}(f)| and a phase spectrum Φ_{ow}(f) of the to-be-measured signal B_{ow}(f) by fast Fourier Transform (FFT); and based on an amplitude relationship and a phase relationship of the reference signal Bₐ(f) before and after wear of the liner, calculating an amplitude spectrum |R_{w}(f)| and a phase spectrum ΦR_{w}(f) of a reflection coefficient of the lubrication film after wear of the liner;
(S3) based on the amplitude spectrum |R_{w}(f)| of the reflection coefficient, calculating a thickness d of the lubrication film via a resonance model or a spring model; and based on the phase spectrum ΦR_{w}(f) of the reflection coefficient, calculating a worn thickness of the liner via a wear model under different thicknesses of the lubrication film.

2. The ultrasonic method of claim 1, wherein in step (S2), the amplitude spectrum |R_{w}(f)| of the reflection coefficient and the phase spectrum ΦR_{w}(f) of the reflection coefficient are respectively calculated as follows:
$$\vert {R}_{w} ( f ) \vert = \frac{\vert {B}_{ow} ( f ) \vert}{\vert {B}_{aw} ( f ) \vert} = \frac{\vert {B}_{ow} ( f ) \vert}{\vert {B}_{a} ( f ) \vert} ; and \\ {Φ}^{{R}_{w}} ( f ) = {Φ}^{{B}_{ow}} ( f ) - {Φ}^{{B}_{aw}} ( f ) = {Φ}^{{B}_{ow}} ( f ) - {Φ}^{{B}_{a}} ( f ) + 4 π f \frac{Δ d}{{c}_{c}} ;$$
wherein B_{aw}(f) is the reference signal after wear of the liner; Δd is the worn thickness of the liner; c_{c} represents sound velocity of the ultrasonic pulses in the liner; f is a frequency of the ultrasonic pulses; and ΦB_{aw}(f) indicates a phase spectrum of the B_{aw}(f).

3. The ultrasonic method of claim 2, wherein a ratio of the Bₐ(f) to the B_{aw}(f) is expressed as follows:
$$\frac{{B}_{a} ( f )}{{B}_{aw} ( f )} = exp ( 4 iπ f \frac{Δ d}{{c}_{c}} ) ;$$
an amplitude ratio of the Bₐ(f) to the B_{aw}(f) is expressed as follows:
$$\frac{\vert {B}_{a} ( f ) \vert}{\vert {B}_{aw} ( f ) \vert} = 1 ;$$
a phase difference between the Bₐ(f) and the B_{aw}(f) is expressed as follows:
$${Φ}^{{B}_{a}} ( f ) - {Φ}^{{B}_{aw}} ( f ) = 4 π f \frac{Δ d}{{c}_{c}} ;$$
wherein i represents imaginary unit.

4. The ultrasonic method of claim 3, wherein the Bₐ(f) and the B_{aw}(f) are respectively calculated as follows:
Bₐ(f)=I(f)exp(2iπftₛ)T_{sc} exp(2iπft_{c})exp(2iπft_{c})T_{cs} exp(2iπftₛ); and
B_{aw}(f)=I(f)exp(2iπftₛ)T_{sc} exp(2iπft_{cw})exp(2iπft_{cw})T_{cs} exp(2iπftₛ);
wherein I(f) indicates the ultrasonic pulses incident on the sliding bearing; tₛ is a propagation time of the ultrasonic pulses in the bearing bush; T_{sc} is an ultrasonic transmission coefficient of the ultrasonic pulses at a bearing bush-liner interface; t_{c} is a propagation time of the ultrasonic pulses in an unworn liner; t_{cw} is a propagation time of the ultrasonic pulses in a worn liner; and T_{cs} is an ultrasonic transmission coefficient of the ultrasonic pulses at a liner-bearing bush interface.

5. The ultrasonic method of claim 1, wherein in step (S3), the thickness d of the lubrication film is calculated via the resonance model through the following equation:
$$d = \frac{m λ}{2} = \frac{{mc}_{0}}{2 {f}_{m}} ;$$
wherein λ is wavelength of the ultrasonic pulses; m is an order of a resonance frequency; and fₘ is an m-th order resonance frequency.

6. The ultrasonic method of claim 1, wherein in step (S3), the thickness d of the lubrication film is calculated via the spring model through the following equation:
$$d = \frac{{ρ}_{o} {c}_{0}^{2}}{2 π {fz}_{1} {z}_{3}} \sqrt{\frac{\vert {R}_{w} ( f ) \vert {( {z}_{1} + {z}_{3} )}^{2} - {( {z}_{1} - {z}_{3} )}^{2}}{1 - {\vert {R}_{w} ( f ) \vert}^{2}}} ;$$
wherein z₁ is an acoustic impedance of the liner, and is calculated as: z₁=ρ₁c_{c}; ρ₁ is a density of the liner; c_{c} represents sound velocity of the ultrasonic pulses in the liner; z₃ is an acoustic impedance of the bearing journal, and is calculated as: z₃=ρ₃c₃; ρ₃ is a density of the bearing journal; c₃ represents sound velocity of the ultrasonic pulses in the bearing journal; ρ₀ is a density of the lubrication film; and c₀ represents sound velocity of the ultrasonic pulses in the lubrication film.

7. The ultrasonic method of claim 1, wherein in step (S3), when the thickness d of the lubrication film is in a resonance model zone, the worn thickness Δd of the liner is calculated as follows:
$$Δ d = \frac{{c}_{c}}{4 π {f}_{m}} ( {Φ}^{{B}_{a}} ( {f}_{m} ) - {Φ}^{{B}_{ow}} ( {f}_{m} ) ) ;$$
wherein fₘ is an m-th order resonance frequency of the ultrasonic pulses at the lubrication film; cc represents sound velocity of the ultrasonic pulses in the liner; ΦBₐ(fₘ) is a phase of the Bₐ(f); and ΦB_{ow}(fₘ) is a phase of the B_{ow}(f).

8. The ultrasonic method of claim 1, wherein in step (S3), when the thickness d of the lubrication film is in a spring model zone, the worn thickness Δd of the liner is calculated as follows:
$$Δ d = \frac{{c}_{c}}{4 π {f}_{c}} ( Φ {R}_{w} ( {f}_{c} ) - Φ {B}_{ow} ( {f}_{c} ) + Φ {B}_{a} ( {f}_{c} ) )$$
wherein f_{c} is a center frequency of the ultrasonic sensor; ΦR_{w}(f_{c}) is a phase of the reflection coefficient, c_{c} represents sound velocity of the ultrasonic pulses in the liner; ΦB_{ow}(f_{c}) is a phase of the B_{ow}(f); and ΦBₐ(f_{c}) is a phase of the Bₐ(f).

9. The ultrasonic method of claim 8, wherein according to a phase formula of the spring model, the phase spectrum ΦR_{w}(f) of the reflection coefficient is calculated as follows:
$${Φ}_{{R}_{w}} ( f ) = arctan ( \frac{4 π f {z}_{1} {z}_{3}^{2} / K}{( {z}_{1} - {z}_{3} ) + 4 {π}^{2} {{f}_{c}^{2} ( {z}_{1} {z}_{3} / K )}^{2}} ) ;$$
wherein
$$K = \frac{{ρ}_{o} {c}_{o}^{2}}{d} ,$$
and K is stiffness of the lubrication film; z₁ is an acoustic impedance of the liner; z₃ is an acoustic impedance of the bearing journal; and f_{c} is a center frequency of the ultrasonic pulses.

10. The ultrasonic method of claim 1, wherein in step (S3), when the thickness of the lubrication film is in a blind zone, a worn thickness Δd of the liner is calculated as follows:
$$Δ d \approx \frac{{c}_{c}}{4 π {f}_{c}} ( Φ {B}_{a} ( {f}_{c} ) - Φ {B}_{ow} ( {f}_{c} ) ) ;$$
wherein f_{c} is a center frequency of the ultrasonic sensor; ΦB_{ow}(f_{c}) is a phase of the B_{ow}(f); and ΦBₐ(f_{c}) is a phase of the Bₐ(f).

11. An ultrasonic system for simultaneously measuring lubrication film thickness and liner wear of a sliding bearing, the sliding bearing comprising a bearing bush, a liner covered on an inner surface of the bearing bush, a lubrication film and a bearing journal; and the ultrasonic system comprising:
an ultrasonic measurement system; and
a processor;
wherein the ultrasonic measurement system comprises an ultrasonic sensor, an ultrasonic pulser-receiver and a digitizer;
the processor is configured to send an instruction to the ultrasonic pulser-receiver to generate a voltage pulse to excite the ultrasonic sensor to generate and transmit ultrasonic pulses to the sliding bearing;
the ultrasonic sensor is configured to receive echo signals reflected from interfaces between different materials of the sliding bearing;
the digitizer is configured to capture and transmit the echo signals to the processor; and
the processor is also configured to:
collect an echo signal of an unworn liner-air interface as a reference signal Bₐ(f);
collect an echo signal of a worn liner-lubrication film interface as a to-be-measured signal B_{ow}(f);
obtain an amplitude spectrum |Bₐ(f)| and a phase spectrum ΦBₐ(f) of the reference signal Bₐ(f), and an amplitude spectrum |B_{ow}(f)| and a phase spectrum ΦB_{ow}(f) of the to-be-measured signal B_{ow}(f) by fast Fourier Transform (FFT);
calculate an amplitude spectrum |R_{w}(f)| and a phase spectrum ΦR_{w}(f) of a reflection coefficient of the lubrication film after wear of the liner based on an amplitude relationship and a phase relationship of the reference signal before and after wear of the liner;
calculate a thickness d of the lubrication film via a resonance model or a spring model based on the amplitude spectrum |R_{w}(f)| of the reflection coefficient; and
calculate a worn thickness of the liner via a wear model under different thicknesses of the lubrication film based on the phase spectrum ΦR_{w}(f) of the reflection coefficient.

12. The ultrasonic system of claim 11, wherein the amplitude spectrum |R_{w}(f)| of the reflection coefficient and the phase spectrum ΦR_{w}(f) of the reflection coefficient are respectively calculated as follows:
$$\vert {R}_{w} ( f ) \vert = \frac{\vert {B}_{ow} ( f ) \vert}{\vert {B}_{aw} ( f ) \vert} = \frac{\vert {B}_{ow} ( f ) \vert}{\vert {B}_{a} ( f ) \vert} ; and$$
$$Φ {R}_{w} ( f ) = Φ {B}_{ow} ( f ) - Φ {B}_{aw} ( f ) = Φ {B}_{ow} ( f ) - Φ {B}_{a} ( f ) + 4 π f \frac{Δ d}{{c}_{c}} ;$$
wherein B_{aw}(f) is the reference signal after the wear of the liner; Δd is the worn thickness of the liner; c_{c} represents sound velocity of the ultrasonic pulses in the liner; f is a frequency of the ultrasonic pulses; and ΦB_{aw}(f) indicates a phase spectrum of the B_{aw}(f).

13. The ultrasonic system of claim 12, wherein a ratio of the Bₐ(f) to the B_{aw}(f) is expressed as follows:
$$\frac{{B}_{a} ( f )}{{B}_{a w} ( f )} = exp ( 4 i π f \frac{Δ d}{{c}_{c}} ) ;$$
an amplitude ratio of the Bₐ(f) to the B_{aw}(f) is expressed as follows:
$$\frac{\vert {B}_{a} ( f ) \vert}{\vert {B}_{a w} ( f ) \vert} = 1 ;$$
a phase difference between the Bₐ(f) to the B_{aw}(f) is expressed as follows:
$$Φ {B}_{a} ( f ) - Φ {B}_{a w} ( f ) = 4 π f \frac{Δ d}{{c}_{c}} ;$$
wherein i represents imaginary unit.

14. The ultrasonic system of claim 13, wherein the Bₐ(f) and the B_{aw}(f) are respectively calculated as follows:
Bₐ(f)=I(f)exp(2iπftₛ)T_{sc} exp(2iπft_{c})exp(2iπft_{c})T_{cs} exp(2iπftₛ); and
B_{aw}(f)=I(f)exp(2iπftₛ)T_{sc} exp(2iπft_{cw})exp(2iπft_{cw})T_{cs} exp(2iπftₛ);
wherein I(f) indicates the ultrasonic pulses incident on the sliding bearing; tₛ is a propagation time of the ultrasonic pulses in the bearing bush; T_{sc} is an ultrasonic transmission coefficient of the ultrasonic pulses at a bearing bush-liner interface; t_{c} is a propagation time of the ultrasonic pulses in an unworn liner; T_{cw} is a propagation time of the ultrasonic pulses in a worn liner; and T_{cs} is an ultrasonic transmission coefficient of the ultrasonic pulses at a liner-bearing bush interface.

15. The ultrasonic system of claim 11, wherein the thickness d of the lubrication film is calculated via the resonance model through the following equation:
$$d = \frac{m λ}{2} = \frac{m {c}_{0}}{2 {f}_{m}} ;$$
wherein λ is wavelength of the ultrasonic pulses; m is an order of a resonance frequency; and fₘ is an m-th order resonance frequency.

16. The ultrasonic system of claim 11, the thickness d of the lubrication film is calculated via the spring model through the following equation:
$$d = \frac{{ρ}_{0} {c}_{0}^{2}}{2 π f {z}_{1} {z}_{3}} \sqrt{\frac{\vert {R}_{w} ( f ) \vert {( {z}_{1} + {z}_{3} )}^{2} - {( {z}_{1} - {z}_{3} )}^{2}}{1 - {\vert {R}_{w} ( f ) \vert}^{2}}} ;$$
wherein z₁ is an acoustic impedance of the liner, and is calculated as: z₁=ρ₁c_{c}; ρ₁ is a density of the liner; c_{c} represents sound velocity of the ultrasonic pulses in the liner; z₃ is an acoustic impedance of the bearing journal, and is calculated as: z₃=ρ₃c₃; ρ₃ is a density of the bearing journal; c₃ represents sound velocity of the ultrasonic pulses in the bearing journal; ρ₀ is a density of the lubrication film; and c₀ represents sound velocity of the ultrasonic pulses in the lubrication film.

17. The ultrasonic system of claim 11, wherein when the thickness d of the lubrication film is in a resonance model zone, the worn thickness Δd of the liner is calculated as follows:
$$Δ d = \frac{{c}_{c}}{4 π {f}_{m}} ( Φ {B}_{a} ( {f}_{m} ) - Φ {B}_{ow} ( {f}_{m} ) ) ;$$
wherein fₘ is an m-th order resonance frequency of the ultrasonic pulses at the lubrication film; c_{c} represents sound velocity of the ultrasonic pulses in the liner; ΦBₐ(fₘ) is a phase of the Bₐ(f); and ΦB_{ow}(fₘ) is a phase of the B_{ow}(f).

18. The ultrasonic system of claim 11, wherein when the thickness d of the lubrication film is in a spring model zone, the worn thickness Δd of the liner is obtained as follows:
$$Δ d = \frac{{c}_{c}}{4 π {f}_{c}} ( Φ {R}_{w} ( {f}_{c} ) - Φ {B}_{ow} ( {f}_{c} ) + Φ {B}_{a} ( {f}_{c} ) ) ;$$
wherein f_{c} is a center frequency of the ultrasonic sensor, ΦR_{w}(f_{c}) is a phase of the reflection coefficient, c_{c} represents sound velocity of the ultrasonic pulses in the liner; ΦB_{ow}(f_{c}) is a phase of the B_{ow}(f); and ΦBₐ(f_{c}) is a phase of the Bₐ(f).

19. The ultrasonic system of claim 18, wherein according to a phase formula of the spring model, the phase spectrum ΦR_{w}(f) is calculated as follows:
$${Φ}_{{R}_{w}} ( f ) = arctan ( \frac{4 π f {z}_{1} {z}_{3}^{2} / K}{( {z}_{1} - {z}_{3} ) + 4 {π}^{2} {{f}_{c}^{2} ( {z}_{1} {z}_{3} / K )}^{2}} ) ;$$
wherein
$$K = \frac{{ρ}_{0} {c}_{0}^{2}}{d} ,$$
and K is stiffness of the lubrication film; z₁ is an acoustic impedance of the liner; z₃ is an acoustic impedance of the bearing journal; and f_{c} is a center frequency of the ultrasonic pulses.

20. The ultrasonic system of claim 11, wherein when the thickness of the lubrication film is in a blind zone, a worn thickness Δd of the liner is calculated as follows:
$$Δ d \approx \frac{{c}_{c}}{4 π {f}_{c}} ( Φ {B}_{a} ( {f}_{c} ) - Φ {B}_{ow} ( {f}_{c} ) ) ;$$
wherein f_{c} is a center frequency of the ultrasonic sensor; c_{c} represents sound velocity of the ultrasonic pulses in the liner; ΦB_{ow}(f_{c}) is a phase of the B_{ow}(f); and ΦBₐ(f_{c}) is a phase of the Bₐ(f).
